(19) United States
(12) Patent Application Publication
(10) Pub. No.: US 2006/0005458 A1
(43) Pub. Date: Jan. 12, 2006

(54) SPINNERBAIT FISHING LURE AND FRAME THEREFOR

(76) Inventors: Jeffrey A. Maki, Kingsford Heights, IN (US); Andrew Reed, Crags Moor, NY (US)

Correspondence Address: HARTMAN & HARTMAN, P.C., 552 EAST 700 NORTH, VALPARAISO, IN, 46383, US

(21) Appl. No.: 11/160,695

(22) Filed: Jul. 6, 2005

Related U.S. Application Data
(60) Provisional application No. 60/521,801, filed on Jul. 6, 2004.

(51) Int. Cl. A01K 85/10

(52) U.S. Cl. 43/42.13

(57) ABSTRACT

A spinnerbait fishing lure and frame therefor that is sufficiently rigid to minimize system losses and thereby create more blade-induced vibration. The frame has a first leg, a second leg extending from the first leg to cause the frame to have a V-shaped profile lying in a plane, and a vertex defined by the first and second legs, wherein the frame at least predominantly has a flat outer cross-sectional shape.

### CROSS REFERENCE TO RELATED APPLICATIONS

This application claims the benefit of U.S. Provisional Application No. 60/521,801, filed Jul. 6, 2004.

### BACKGROUND OF THE INVENTION

The present invention generally relates to spinnerbaits and related fishing lures, and more particularly a spinnerbait fishing lure frame constructed and formed in a manner that yield a fishing lure capable of performing more effectively than previous spinnerbait-type lures.

Spinnerbaits are a type of fishing lure that attract fish by creating vibration and movement in the water. Spinnerbaits generally have a V or L-shaped frame formed of bent wire to define two legs. One or more blades or spinners are mounted with swivels and/or stirrup-shaped devises to one of the legs so as to be able to rotate as the lure is drawn through the water. The distal end of the second leg carries a hook, while an eyelet or other suitable feature for attaching a fishing line is formed at or near the vertex of the wire frame formed by the two legs. A weight is carried on the second leg adjacent the hook, as is typically a bait capable of attracting fish, such as a soft plastic worm or a skirt that hides the hook and ripples as the lure is drawn through the water. Due to the placement of the weight on the wire frame, the leg with the attached blades is above the leg with the hook and bait as the lure is drawn through the water.

Movement of the blades of a spinnerbait is the primary attraction mechanism to a targeted fish. Blade motion is induced by the motion of the lure through the water both as the lure drops down to the desired retrieval depth and during retrieval. Vibrations in the water created by the motion of the blades are particularly attractive to predatory fish, since the vibrations are interpreted as the motion of a small wounded bait fish.

In view of the above, it has been accepted that the frame of a spinnerbait must be flexible in order to maximize the vibrations that will attract fish as the lure moves through the water. In the past, the required flexibility has been typically achieved by producing the frame from flexible wire having a round cross-sectional shape. To promote flexibility, spinnerbait frames have also been formed from alloys, including shape-memory alloys such as nickel-titanium alloys (e.g., NITINOL®), chosen for their ability to provide extreme flexibility rather than rigidity.

### BRIEF SUMMARY OF THE INVENTION

The present invention provides a spinnerbait fishing lure and frame therefor that is sufficiently rigid to create more blade-induced vibration.

The frame comprises a first leg, a second leg extending from the first leg to cause the frame to have a V-shaped profile lying in a plane, and a vertex defined by the first and second legs, wherein the frame at least predominantly has a flat outer cross-sectional shape. According to a preferred aspect of the invention, the frame exhibits greater rigidity to deflection in the plane of the frame than to deflection out of the plane of the frame.

In view of the above, it is believed that the frame greatly reduces system losses to promote more blade-induced vibration in the lure than possible with spinnerbaits having conventional flexible frames with round cross-sections. By minimizing system losses, the energy provided by movement of bait attached to the frame when traveling through the water is most efficiently transmitted to the blades and converted into blade motion and resultant vibrations for attracting fish. A pronounced resonant frequency can also be achieved with the frame because, in addition to minimal system losses, its reactance is high and vibrational bandwidth is relatively narrow.

An additional benefit of the rigid frame of this invention is its extreme responsiveness when a jerk-retrieve is used because acceleration immediately translates into blade movement rather than bending of the frame due to inertia, as occurs with conventional flexible frames with round cross-sections. Inertia of a blade attached to the first leg of the frame is able to be more efficiently fed back to the bait attached to the second leg of the frame, inducing greater motion in the bait to create the illusion that the bait is a wounded bait fish.

Other objects and advantages of this invention will be better appreciated from the following detailed description.

### BRIEF DESCRIPTION OF THE DRAWINGS

FIG. 1 is a side view of a spinnerbait fishing lure in accordance with an embodiment of this invention.

FIG. 2 is a side view of a frame of the lure of FIG. 1.

FIG. 3 is a cross-sectional view of the frame of FIG. 2.

### DETAILED DESCRIPTION OF THE INVENTION

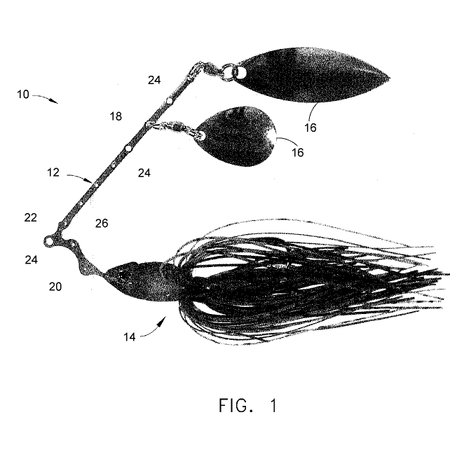

Illustrated in FIG. 1 is a spinnerbait fishing lure 10 of a type that can be produced with a frame 12 in accordance with the present invention. As is generally conventional, the lure 10 includes a bait 14 and blades (spinners) 16. The blades 16 are mounted with swivels or other suitable connectors to enable the blades 16 to rotate and vibrate as the lure 10 travels through water, thereby inducing vibrations in the water and motion in the bait 14. While the bait 14 is shown configured to resemble a fish with a skirt to hide one or more hooks (not shown) attached to the bait 14, the invention is not limited to any particular type or shape of bait 14. Similarly, while the lure 10 is shown equipped with two blades 16, the invention is not limited to any particular number, shape, size, etc., of blades 16.

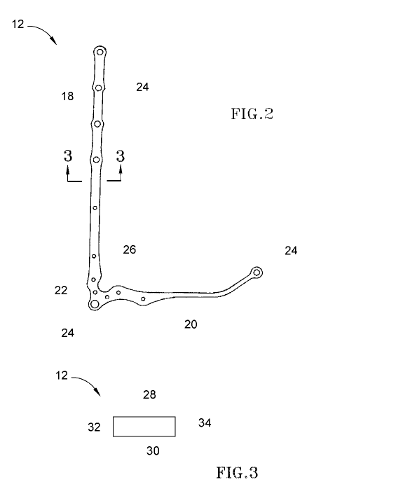

The frame 12 of the lure is shown in greater detail in FIGS. 2 and 3. The frame 12 has a generally V-shaped or L-shaped profile in a plane defined by a pair of legs 18 and 20 that intersect to define a vertex 22 of the frame 12. Suitable lengths for the legs 18 and 20 are about 2.75 and 1.78 inches (about 7 and about 4.5 centimeters), respectively, though it is foreseeable that the absolute and relative lengths of the legs 18 and 20 could differ. As depicted in FIG. 2, the legs 18 and 20 are generally oriented about ninety degrees to each other, though this also could be varied. The legs 18 and 20 and vertex 22 are formed to have through-holes 24. By referring back to FIG. 1, it can be seen that some of the through-holes 24 in the first leg 18 define locations at which the blades 16 are attached to the upper leg 18, and a through-hole 24 on the lower leg 20 provides a location for attaching the bait 14. The through-hole 24 located at the vertex 22 provides a location at which a fishing line (not shown) can be attached to the frame 12. A suitable diameter for the through-holes 24 in the legs 18 and 20 is about 0.06 inch (about 1.5 millimeters), and a suitable spacing for the through-holes 24 along the length of the first leg 18 is about 0.375 inch (about 1 centimeter) apart. The through-hole 24 at the vertex 22 is preferably larger, for example, about 0.08 inch (about 2 millimeters) in diameter. As shown, additional through-holes 26 may also be defined in the frame 12.

From FIGS. 2 and 3, it is evident that the frame 12 does not have a round cross-sectional shape, but instead predominantly has a flat outer cross-sectional shape. By predominantly, the intent is that a sufficient portion of the length of the frame 12 has the desired flat outer cross-sectional shape to produce a measurable increase in the rigidity of the frame 12. In FIG. 3, it can be seen that the flat outer cross-sectional shape of the frame 12 is defined in part by two oppositely-disposed surfaces 28 oriented generally parallel to the plane of the frame 12. An oppositely-disposed second pair of surfaces 32 and 34 intersect the first pair of surfaces 28 and 30, resulting in the frame 12 having a quadrangular cross-sectional shape. Though its dimensions (including dimensional ratios) can vary and through-holes 24 and 26 are present, the frame 12 preferably has a flat outer cross-sectional shape, more preferably the quadrangular-shaped cross-section exterior shown in FIG. 3, throughout its extent. As will be discussed below, the first pair of surfaces 28 and 30 are generally flat and substantially parallel to the plane of the frame 12. The second surfaces 32 and 34 may also be flat and generally perpendicular to the plane of the frame 12 (and therefore perpendicular to the first surfaces 28 and 30), though tolerances and irregularities during forming of the frame 12 will not necessarily result in the second surfaces 32 and 34 being as flat as the first surfaces 28 and 30.

As seen from FIG. 3, the cross-section of the frame 12 is such that the width of the frame 12 (in the plane of the frame 12) is significantly greater than the thickness of the frame 12 (in the direction transverse to the plane of the frame 12). The first pair of surfaces 28 and 32 are shown as consistently having an outermost width dimension (defining the width of the frame 12) that is greater than an outermost width dimension (defining the thickness of the frame 12) of the second pair of surfaces 32 and 32. As a result, the frame 12 exhibits greater rigidity to deflection in the plane of the frame 12 than to deflection out of the plane of the frame 12. From FIG. 2, it can be seen that the outermost width dimensions of the surfaces 28 and 30 are not constant but vary along the lengths of the legs 18 and 20, due at least in part to accommodate the presence of the through-holes 24 and 26. Though not limited to any particular dimensions, a suitable width for the leg 18 between through-holes 24 is about 0.09 inch (about 2.3 millimeters), a suitable width for the leg 20 between the cluster of through-holes 26 and the through-hole 24 is about 0.04 inch (about 1 millimeter), and a suitable width for the legs 18 and 20 across each through-hole 24 is about 0.12 inch (about 3 millimeters). In contrast, the outermost width dimensions of the second surfaces 32 and 34 can be substantially uniform along the entire lengths of the legs 18 and 20, and generally will be constant if the frame 12 is formed from flat stock. As defined by the width dimensions of the second surfaces 32 and 34, a suitable thickness for the frame 12 is about 0.032 inch (about 0.8 millimeter).

As seen in FIG. 2, the leg 18 is substantially straight while the other leg 20 has a substantially straight portion immediately adjacent the first leg 18, a distal portion defining the distal end of the second leg 20, and a curved portion between and adjoining the straight and distal portions such that the distal portion is not parallel to the straight portion. The through-hole 24 located in the second leg 20 is formed at the distal end of the second leg 20, and as a result of the curved portion is offset from the straight portion of the second leg 20, such as by about 0.32 inch (about 8 millimeters).

As noted above, a preferred aspect of the invention is that the frame 12 is relatively rigid, more so than conventional spinnerbait lure frames formed from round wire. While a variety of materials could be used to form the frame 12 of this invention, a preferred material is high tensile strength stainless steel. Titanium and its alloys can also be used, though in contrast to previous flexible frames formed for shape-memory nickel-titanium alloys, suitable titanium alloys for use with this invention do not contain intentional additions of nickel that would result in the flexible, shape-memory effect. Instead, suitable titanium alloys exhibit a very low modulus of elasticity after heat treatment. As also previously mentioned, the frame 12 can be formed from flat stock so that the frame 12 and each of its legs 18 and 20 can be readily produced to have the desired flat outer cross-sectional shape defined by the surfaces 28 and 30. A suitable method for forming the frame 12 is by stamping, particularly if the starting material is flat stock. Alternative forming processes are also possible and within the scope of this invention. For example, the frame 12 could be machined (e.g., laser cut, EDM, etc.) from flat stock, which would yield a rectangular cross-sectional shape as a result of the surfaces 32 and 34 being flatter and perpendicular to the surfaces 28 and 30. Other suitable processes include metal injection molding (MIM) and induction casting techniques.

While not wishing to be held to any particular theories, the benefits of the rigid frame 12 of this invention are believed to be affirmed on the basis of the quality factor (Q) attainable with the frame 12. As known, quality factor is a measure of loss (or efficiency) in electrical or mechanical systems relating to a system's resonant frequency, and is generally based on the relationship:
Q=Reactance Resistance
which in turn is derived from
Resonant Frequency F
where
F=(high cutoff frequency)−(low cutoff frequency)(upper & lower cutoffs defined by −3 dB or 2 power roll-offs)

Because of its cross-sectional shape, the frame 12 of this invention is considerably more rigid than frames formed of round wire. The rigidity of the frame 12 can be promoted by forming the frame 12 so that the in-plane surfaces 28 and 30 are wider than the transverse surfaces 32 and 40, which greatly reduces flexure of the frame 12 in directions within the plane of the frame 12 and therefore in the rearward direction as the lure 10 is pulled through the water. It is believed that the rigidity of the frame 12 minimizes system losses (e.g., attributable to flexure), maximizes reactance, and provides a relatively narrow vibrational bandwidth, which in turn is believed to achieve a more pronounced resonant frequency. On this basis, the frame 12 of this invention can be characterized as a high-Q frame, especially when compared to previous spinnerbait frames formed from bent round wire of less rigid materials, and therefore readily and equally flexible in all directions transverse to the axis of the wire.

While the invention has been described in terms of a preferred embodiment, it is apparent that other forms could be adopted by one skilled in the art. For example, the physical configuration of the lure 10 and frame 12 could differ from that shown, and materials, dimensions, and processes other than those noted could be use. Therefore, the scope of the invention is to be limited only by the following claims.

What is claimed is:

1. A spinnerbait fishing lure having a frame comprising a first leg, a second leg extending from the first leg to cause the frame to have a V-shaped profile lying in a plane, and a vertex of the frame defined by the first and second legs, wherein the frame at least predominantly has a flat outer cross-sectional shape.

2. A spinnerbait fishing lure according to claim 1, wherein the flat outer cross-sectional shape of the frame is at least predominantly defined by oppositely-disposed planar surfaces substantially parallel to the plane of the frame.

3. A spinnerbait fishing lure according to claim 1, wherein the flat outer cross-sectional shape of the frame at least predominantly has a quadrangular shape defined by an oppositely-disposed first pair of flat surfaces substantially parallel to the plane of the frame and an oppositely-disposed second pair of surfaces intersecting the first pair of surfaces.

4. A spinnerbait fishing lure according to claim 1, wherein the flat outer cross-sectional shape of the frame is defined by an oppositely-disposed first pair of flat surfaces substantially parallel to the plane of the frame and an oppositely-disposed second pair of surfaces intersecting the first pair of surfaces, wherein each of the first pair of surfaces has an outermost width dimension that is greater than an outermost width dimension of each of the second pair of surfaces such that the frame exhibits greater rigidity to deflection in the plane of the frame than to deflection out of the plane of the frame.

5. A spinnerbait fishing lure according to claim 4, wherein the outermost width dimensions of the first pair of surfaces are not constant but vary along the lengths of the first and second legs, and wherein the outermost width dimensions of the second pair of surfaces are substantially constant along the lengths of the first and second legs.

6. A spinnerbait fishing lure according to claim 1, wherein the first leg is substantially straight.

7. A spinnerbait fishing lure according to claim 1, wherein the second leg has a substantially straight portion immediately adjacent the first leg, a distal portion defining a distal end of the second leg, and a curved portion between and adjoining the straight and distal portions such that the distal portion is not parallel to the straight portion.

8. A spinnerbait fishing lure according to claim 1, further comprising through-holes defined in the frame and extending through a thickness of the flat outer cross-sectional shape.

9. A spinnerbait fishing lure according to claim 8, wherein the thickness of the flat outer cross-sectional shape of the frame is defined by a distance between two oppositely-disposed planar surfaces substantially parallel to the plane of the frame.

10. A spinnerbait fishing lure according to claim 8, further comprising means for attaching at least one rotatable blade to the first leg, means for attaching a hook to the second leg, and means for attaching a fishing line to the frame, wherein at least one of the blade-attaching means, the hook-attaching means, and the line-attaching means comprises at least one of the through-holes.

11. A spinnerbait fishing lure according to claim 10, wherein each of the blade-attaching means, the hook-attaching means, and the line-attaching means comprises at least one of the through-holes.

12. A spinnerbait fishing lure according to claim 8, wherein a plurality of the through-holes are defined and spaced along the length of the first leg.

13. A spinnerbait fishing lure according to claim 1, wherein the frame is formed of a stainless steel or a titanium alloy free of any intentional additions of nickel.

14. A spinnerbait fishing lure according to claim 1, wherein the frame is formed by a process chosen from the group consisting of injection molding, induction casting, and stamping.

15. A spinnerbait fishing lure according to claim 1, further comprising a rotatable blade attached to the first leg of the frame.

16. A spinnerbait fishing lure according to claim 1, further comprising a hook attached to the second leg of the frame.

17. A spinnerbait fishing lure according to claim 16, further comprising a bait attached to the second leg of the frame adjacent the hook so as to conceal the hook.

18. A spinnerbait fishing lure frame formed to have a first leg, a second leg extending from the first leg to cause the frame to have a V-shaped profile lying in a plane, a vertex defined by the first and second legs, means for attaching at least one blade to the first leg, means for attaching a hook to the second leg, and means for attaching a fishing line to the frame, wherein each of the frame and the first and second legs thereof has a flat outer cross-sectional shape.

19. A spinnerbait fishing lure frame according to claim 18, wherein the flat outer cross-sectional shape of the frame is defined by an oppositely-disposed first pair of flat surfaces substantially parallel to the plane of the frame and an oppositely-disposed second pair of surfaces intersecting the first pair of surfaces, wherein each of the first pair of surfaces has an outermost width dimension that is greater than an outermost width dimension of each of the second pair of surfaces such that the frame exhibits greater rigidity to deflection in the plane of the frame than to deflection out of the plane of the frame.

20. A spinnerbait fishing lure frame according to claim 18, further comprising through-holes defined in the frame and extending through a thickness of the flat outer cross-sectional shape, wherein at least one of the blade-attaching means, the hook-attaching means, and the line-attaching means comprises at least one of the through-holes.
